(19) United States
(12) Patent Application Publication
(10) Pub. No.: US 2005/0003262 A1
(43) Pub. Date: Jan. 6, 2005

(54) SOLID-STATE FUEL CELL AND RELATED METHOD OF MANUFACTURE

(76) Inventor: Rajiv Doshi, Torrance, CA (US)

Correspondence Address: NIXON & VANDERHYE P.C./G.E., 1100 N. GLEBE RD., SUITE 800, ARLINGTON, VA, 22201, US

(21) Appl. No.: 10/604,226

(22) Filed: Jul. 2, 2003

(51) Int. Cl. H01M 4/86; H01M 4/88; H01M 8/12

(52) U.S. Cl. 429/40; 502/101; 264/618; 429/30

(57) ABSTRACT

An electrode for a solid-state fuel cell includes a tape having opposite sides joined by a peripheral edge, one of the opposite faces having a plurality of surface depressions therein extending partially through the tape.

### BACKGROUND OF INVENTION

The invention relates generally to solid-state fuel electrodes, and more specifically, to an anode configuration for a solid oxide fuel cell (SOFC).

A fuel cell is an electrochemical device in which a hydrogen or a hydrocarbon fuel is electrochemically reacted with air or oxygen to produce electricity, heat and water. A fuel cell typically includes an anode (the fuel electrode) and a cathode (the oxidant electrode). The anode and cathode are made of porous materials that allow gases to move through them. In a solid oxide fuel cell (SOFC), a hard ceramic electrolyte separates the anode from the cathode.

SOFC's typically operate at temperatures as high as 1000° C. Oxygen ions are formed at the oxidant electrode (the cathode), and when the hydrogen or other hydrocarbon fuel is passed over the fuel electrode (the anode), oxygen ions migrate through the hard ceramic electrolyte to oxidize the fuel, transforming the hydrogen to water and carbon monoxide to carbon dioxide while releasing electrons. The electrons move out through an external circuit to create electricity.

SOFC's are typically either anode-supported or electrolyte-supported, thus determining which component is the thickest, and to which component the remaining components are attached.

Persistent problems relating to SOFC anode design is the need to insure flatness of the component interface surfaces during fabrication as well as efficiency of fuel utilization during operation.

Anodes in anode-supported SOFC's exhibit lower capability for fuel utilization than anodes in electrolyte-supported SOFC's, because the thickness of the anode in anode-supported SOFC's (typically 0.3 to 2 mm) is typically much larger than anodes in electrolyte-supported SOFC's (e.g., 0.01 to 0.1 mm). Secondly, anodes are generally more dense in anode-supported SOFC's since they are fired along with electrolytes at high temperatures required to densify the electrolytes. Higher density anodes lead to more diffusion resistance and therefore reduced capability for high-fuel utilization operation.

Attempts to improve anode fuel utilization have included adding more poreformers to the anode to create more porosity and lower resistance to gas diffusion through the anode upon firing. Added poreformers, however, lead to problems in fabrication such as increased stiffness and brittleness in tape calendaring or tape casting operations which, in turn, makes lamination with the electrolyte layer difficult. In addition, the poreformers are organics which must be burnt out of the anode during firing. This can lead to increased and often uneven heat generation, and decreased yield from slowing down the firing cycle, which adds significantly to cost.

Another technique has been to reduce firing temperature of the anode to prevent densification during sintering and preserve more porosity. This approach is usually accompanied by inadequate densification of the electrolyte, however, leading to leaks through the electrolyte and lower performance of the cell, or even outright cell failure.

Still another technique has been to reduce the anode thickness, to thereby create a shorter path length and therefore easier diffusion or transport of fuel and oxidized products to and from the anode/electrolyte interface. This approach, however, leads to decreased strength of the anode, increased warpage and lower yield.

Prior approaches for achieving improved flatness for the anode have included embedding a strip or bar of electrolyte on the anode side so that during cool-down from sintering temperatures, the electrolyte bar prevents the anode from shrinking at a different rate than the electrolyte. Another approach has been to emboss a honeycomb pattern on the anode or electrolyte to impart structural resistance to warpage.

### SUMMARY OF INVENTION

The present invention uses existing materials and compositions for anode-supported SOFC's and only slightly modifies the fabrication process so as to provide increased flatness during fabrication, as well as enhanced fuel utilization during operation. It will be understood, however, that the invention is equally applicable to cathodes in cathode-supported SOFC's and may also have applicability in the construction of anodes and cathodes in proton exchange membrane fuel cells (PEM) that use fluorocarbon ion exchange with a polymeric membrane as the electrolyte.

More specifically, in the exemplary embodiment, the invention provides an SOFC anode structure with its typical thickness unchanged, but with holes or surface depressions extending part way from the anode outer or exposed surface into the interior of the anode. The result is a structure with the same overall thickness and hence substantially the same structural strength and yield, but with openings that take the fuel gases partway into the anode structure and also allow the products to exit after traveling a shorter path through the anode structure. If the pattern is created in the ceramic anode during the green state (before firing), such as by die punching a green ceramic tape, then the structure will also exhibit reduced warpage upon cooling from sintering temperature since there is space for stress relief in part of the structure where partial holes exist.

Accordingly, in its broader aspects, the invention relates to an electrode for a solid-state fuel cell comprising a tape having opposite sides joined by a peripheral edge, one of the opposite faces having a plurality of surface depressions therein extending partially through the tape.

In another aspect, the invention relates to a method of forming a multi-layer assembly for a solid-state fuel cell comprising providing a ceramic tape layer; laminating the ceramic tape layer onto one side of an electrolyte tape layer to create the multi-layer assembly; creating a pattern of surface depressions on one side of the ceramic tape layer; and thereafter firing the multi-layer assembly.

In still another aspect, the invention relates to a solid oxide fuel cell comprising an anode, a cathode and an electrolyte, the anode and cathode arranged on opposite sides of the electrolyte, one of the anode and the cathode having a plurality of surface depressions formed in an exposed side thereof, extending partially through the one of the anode and cathode.

The invention will now be described in detail in connection with the drawings identified below.

### BRIEF DESCRIPTION OF DRAWINGS

FIG. 1 is a schematic diagram of a conventional SOFC;

FIG. 2 is a front elevation of an SOFC anode in accordance with an exemplary embodiment of the invention;

FIG. 3 is a plan view of the anode in FIG. 2; and

FIG. 4 is a plan view of an SOFC anode in accordance with an alternative embodiment of the invention.

### DETAILED DESCRIPTION

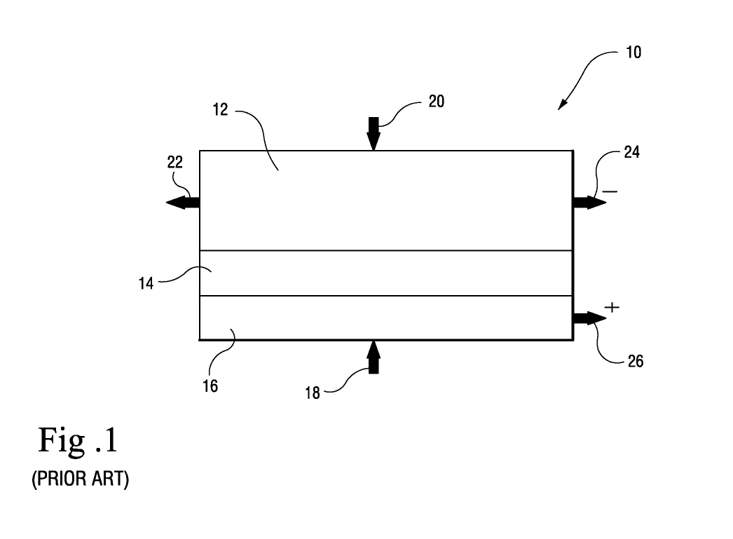

With reference to FIG. 1, a conventional anode-supported SOFC is shown schematically at 10 and includes an anode 12, electrolyte 14 and cathode 16. The anode 12 is significantly thicker than both the cathode and electrode in the anode-supported type SOFC. In a typical example, the cathode 16 and electrolyte 14 may have thicknesses of about 0.01 to 0.10 mm while the anode 12 may have a thickness of about 0.3 to 2 mm.

The anode 10 is a ceramic material, e.g., a nickel/zirconium oxide, and the cathode is also a ceramic material, e.g., lanthanum manganite. Both the anode 12 and cathode 16 are relatively porous, allowing gases to pass through for interaction with the electrolyte 14. The electrolyte may comprise a mixture of yttrium oxide and zirconium oxide. It will be appreciated, however, that other suitable compositions may be utilized in connection with this invention.

In an SOFC, oxygen is added via the cathode 16 as indicated by arrow 18; hydrogen and carbon monoxide are added to the anode 12 as indicated by arrow 20. The electrolyte 14 conducts oxygen ions from the cathode 16 to the anode 12 and, as the negatively charged ions combine with hydrogen, water and heat are expelled from the anode 12 as indicated by arrow 22. The negatively charged ions on the anode side supply electrons that return through an external load to the cathode side, producing a flow of electricity, indicated by arrows 24, 26. This fundamental operation of the fuel cell is well understood and is not per se a part of this invention.

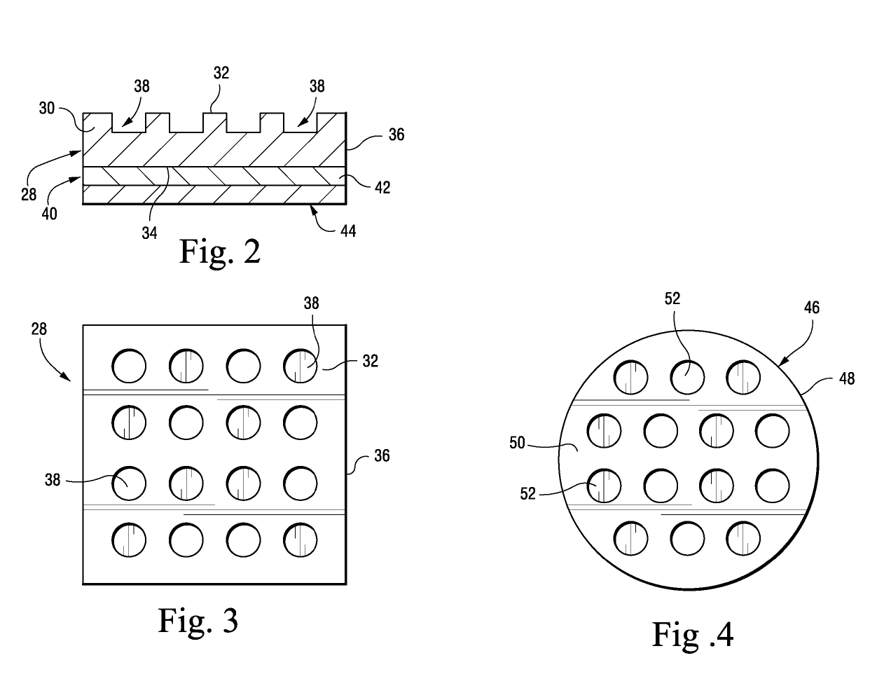

Turning to FIG. 2, the electrode 28 is the anode in the exemplary embodiment of the SOFC. The electrode (or anode) 28 is formed as an anode tape or film layer 30 with two opposite sides 32 and 34 joined by a peripheral edge 36. The upper or exposed side 32 of the anode is fabricated with a plurality of surface depressions 38 which, in the example shown, are in the form of round, partial holes that extend into the anode a predetermined depth, e.g., up to about 90% and preferably about 65-70% of the thickness of the tape 30. For example, the anode tape 30 may have a thickness of about 13.5 mils and the holes 38 may have a depth of about 9 mils. The lower, flat side 34 of the anode tape 30 is joined to an electrolyte 40, also in the form of an electrolyte tape or film layer 42 on one side thereof, while the opposite side of the electrolyte is joined to the cathode or cathode layer 44.

The holes 38 may have a diameter of about 5 microns to 5 mm and preferably about 200 microns, but it will be understood that the diameter as well as the depth, number and array pattern of the holes may be varied depending on specific application. The spacing between the holes 38 may be equal to the diameter of the holes, but this may vary from greater than or equal to, to slightly less than, the diameter of the holes.

In the exemplary embodiment, the anode tape 30 is fabricated by forming the surface depressions or partial holes 38 while the ceramic anode tape 30 is still in the green stage. This may be accomplished by laminating the anode tape 30 with the electrolyte tape 42 to form a multi-layer assembly, die punching the depressions in the “green” anode tape 30 and then firing. After firing and upon cooling, the anode will exhibit reduced warpage from the sintering temperature since the holes 38 provide space for stress relief. The bi-layer assembly may then be laminated to the cathode layer 44.

It will be understood that the cathode layer 44 may also be in ceramic tape form and may be laminated to the anode and electrolyte layers to form a tri-layer assembly prior to forming the depressions in the anode tape.

FIG. 4 shows an alternative anode design where the anode tape or layer 46 is formed such that the peripheral edge 48 thereof defines a circle, and the upper or exposed side 50 is formed with a plurality of round surface depressions, or partial holes 52 that are otherwise similar to holes 38. It will be appreciated that the shape of the anode will, in part, determine how the array of partial holes 38 or 46 are arranged on the surface of the anode layer 36. In addition, while the holes 38, 52 are shown as round, they may be any shape such as square, hexagonal, octagonal, etc.

It will also be understood that the invention is equally applicable to the cathode component of SOFC's with similar benefits, and may also be applicable to anode and cathode components of other solid state fuel cells such as PEM fuel cells.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. An electrode for a solid-state fuel cell comprising a tape having opposite sides joined by a peripheral edge, one of said opposite faces having a plurality of surface depressions therein extending partially through said tape.

2. The electrode of claim 1 wherein said surface depressions comprise an array of round holes.

3. The electrode of claim 1 wherein said tape is substantially square.

4. The electrode of claim 1 wherein said tape is substantially round.

5. The electrode of claim 1 wherein said surface depressions have a depth of about 10-90% of the depth of the tape.

6. The electrode of claim 1 wherein said tape is comprised of a ceramic material.

7. The electrode of claim 1 wherein said tape has a thickness of from about 0.3 to about 2 mm.

8. The electrode of claim 7 wherein said surface depressions have a depth of about 0.23 mm.

9. The electrode of claim 2 wherein said surface depressions have a depth of about 0.23 mm and said tape has a thickness of about 0.33 mm.

10. The electrode of claim 2 wherein said electrode comprises an anode for a solid oxide fuel cell.

11. A method of forming a multi-layer assembly for a solid-state fuel cell comprising:
providing a ceramic tape layer;
laminating said ceramic tape layer onto one side of an electrolyte tape layer to create the multi-layer assembly;
creating a pattern of surface depressions on one side of the ceramic tape layer; and thereafter
firing said multi-layer assembly.

12. The method of claim 11 wherein said surface depressions comprise an array of round holes.

13. The method of claim 11 wherein said ceramic tape layer is substantially square.

14. The method of claim 11 wherein said ceramic tape layer is substantially round.

15. The method of claim 11 wherein said surface depressions have a depth of about 65-70% of the depth of said ceramic tape layer.

16. The method of claim 11 wherein said ceramic tape layer has a thickness of from about 0.3 to about 2 mm.

17. The method of claim 16 wherein said surface depressions have a depth of about 0.23 mm.

18. The method of claim 10 wherein said surface depressions have a depth of about 0.23 mm and said ceramic tape layer has a thickness of about 0.33 mm.

19. The method of claim 11 wherein said surface depressions are formed by die punching.

20. The method of claim 11 wherein said ceramic tape layer comprises an anode for a solid oxide fuel cell.

21. The method of claim 11 and further comprising laminating another ceramic tape layer on an opposite side of said electrolyte tape layer prior to creating said pattern of surface depressions on said one side of said ceramic tape layer.

22. A solid oxide fuel cell comprising an anode, a cathode and an electrolyte, said anode and cathode arranged on opposite sides of said electrolyte, at least one of said anode and said cathode having a plurality of surface depressions formed in an exposed side thereof, extending partially through said one of said anode and cathode.

23. The solid oxide fuel cell of claim 22 wherein said plurality of surface depressions are formed in the exposed side of the anode.

24. The solid oxide fuel cell of claim 23 wherein said surface depressions comprise an array of round holes.

25. The solid oxide fuel cell of claim 22 wherein said anode is substantially square.

26. The solid oxide fuel cell of claim 22 wherein said anode is substantially round.

27. The solid oxide fuel cell of claim 22 wherein said surface depressions have a depth of about 10-90% of the depth of the anode.

28. The solid oxide fuel cell of claim 22 wherein said anode has a thickness of from about 0.3 to about 2 mm.

29. The solid oxide fuel cell of claim 22 wherein said surface depressions have a depth of about 0.23 mm.

30. The solid oxide fuel cell of claim 22 wherein said surface depressions have a depth of about 0.23 mm and said anode has a thickness of about 0.33 mm.

31. The solid oxide fuel cell of claim 23 wherein said anode is comprised of a ceramic tape laminated onto said electrolyte.
